(19) United States
(12) Patent Application Publication
(10) Pub. No.: US 2009/0006144 A1
(43) Pub. Date: Jan. 1, 2009

(54) Ticket Use System and Ticket Use Method

(76) Inventor: Keiichi Nakajima, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 11/908,439

(22) PCT Filed: Feb. 23, 2006
(86) PCT No.: PCT/JP2006/303257

§ 371 Date: Sep. 12, 2007

(30) Foreign Application Priority Data
Apr. 7, 2005 (JP) 2005-110508

(51) Int. Cl. G06Q 10/00

(52) U.S. Cl. 705/5

(57) ABSTRACT

A ticket use system having a high safety and a high operability and suited to be put into practical use. In the ticket use system, a strap tag storing first identification information is given to the user. When reservation of a reserved seat is made through a cellular phone, the reservation content is displayed, and a card tag storing second identification information is given to the user. The strap tag and the card tag are used as tickets. When the user registers seat type information through the cellular phone at the reservation and when the seat type information represents a nonreserved seat, the first identification information is stored as ticket authentication information in a ticket DB. When the seat type information represents a reserved seat, the second identification information is stored as ticket authentication information in the ticket DB.

### TECHNICAL FIELD

The present invention relates to a ticket use system and a ticket use method for using a data carrier such as an IC tag as a ticket.

### BACKGROUND ART

When a user goes to see events such as a concert and a play, the user normally goes to a ticket office and gets a paper ticket by paying a ticket fee. Nowadays, due to a development of an information communication technology, other systems are also suggested in which an IC card storing ticket information or a cellular phone are used as tickets (for example, Japanese Unexamined Patent Application Publications No. 2002-163689 and No. 2002-109343). In such a system in which the IC card or the cellular phone are used as the tickets, when one user makes a reservation of a plurality of reserved seats, each user for each seat has to transact through their own cellular phones to get the ticket information, which is inconvenient. Another system is also suggested in which a plurality of ticket information is obtained through a single cellular phone to exchange information among a plurality of cellular phones. However, data communication among the cellular phones is tiresome for the users and the availability is still low.

In addition, another system is also suggested in which the ticket can be issued even when the user does not go to the ticket office (for example Japanese Unexamined Patent Application Publication No. 2002-42069). In the system disclosed in Japanese Unexamined Patent Application Publication No. 2002-42069, when the user applies for the ticket through the Internet, a postcard embedded a non-contact IC card storing the ticket information is mailed to the user who applied for the ticket. When the user inserts the non-contact IC card into an ATM equipped with a card reader writer and pays for the ticket fee, the information inside the non-contact IC card is rewritten and the non-contact IC card in which the information is rewritten functions as an authorized ticket.

### [Patent Document 1]

### Japanese Unexamined Patent Application Publication No. 2002-163689

### [Patent Document 2]

### Japanese Unexamined Patent Application Publication No. 2002-109343

### [Patent Document 3]

### Japanese Unexamined Patent Application Publication No. 2002-42069

### DISCLOSURE OF THE INVENTION

### Problems to be Solved by the Invention

However, in the system disclosed in Japanese Unexamined Patent Application Publication No. 2002-42069, no measure has been taken against the case when the card embedded the non-contact IC card has not properly distributed to the user, which causes confusion for both the user and a ticket issuer. In addition, in the system disclosed in Japanese Unexamined Patent Application Publication No. 2002-42069, it does not suggest issuing a ticket according to a seat type such as a nonreserved seat or a reserved seat.

It is an object of the present invention to overcome the above problems and to provide a ticket use system having a high safety and a high operability and suited to be put into practical use.

### Means for Solving the Problems

A ticket use system according to the present invention is a ticket use system using a first data carrier and a second data carrier as tickets, the first data carrier being distributed to a user in advance and storing first identification information, and the second data carrier being distributed to the user according to a reservation of a reserved seat, displaying reservation information, and storing second identification information, the ticket use system including: a ticket database for storing at least ticket authentication information used for authenticating the tickets; means for obtaining seat type information input by the user; means for storing the first identification information in the ticket database as the ticket authentication information when the obtained seat type information represents a nonreserved seat; and means for storing the second identification information in the ticket database as the ticket authentication information when the obtained seat type information represents a reserved seat. By having such a configuration, the first data carrier and the second data carrier can be used as the tickets. Specifically, when the user made the reservation of the nonreserved seat, the first data carrier which was distributed in advance is used as the ticket. Therefore, there is no need to mail the data carrier each time the reservation is made, which makes it possible to reduce the burden of a ticket issuer. When the user made the reservation of the reserved seat, the second data carrier displaying the reservation information is used as the ticket. Therefore, the user can easily recognize the reservation information by just checking the second data carrier and easily grasp the content of the ticket. It is also convenient when the user tries to find the seat at the event venue.

It is also desirable that the ticket use system includes means for obtaining transaction completion information regarding a ticket fee and stores the first identification information or the second identification information in the ticket database when it is determined by the transaction completion information that the transaction of the ticket fee is completed. By having such a configuration, it is possible to authenticate the ticket only after the transaction is completed. In other words, the tag functions as the ticket only after the transaction is completed. Therefore, it is possible to mail the tag in a simple and convenient way.

It is also advantageous that the ticket use system includes: means for obtaining from the user reception information indicating whether the user has received the second data carrier distributed to the user according to the reservation of the reserved seat; and means for storing the second identification information in the ticket database when it is determined based on the reception information that the user has received the second data carrier. By having such a configuration, the second data carrier functions as the ticket only after the user receives the second data carrier. So even when other persons obtained the second data carrier, it is difficult to make the second data carrier available as the ticket, which makes it possible to prevent unauthorized use of the ticket by other persons.

It is also desirable that the ticket use system includes: a nonarrival database for storing nonarrival information confirmed for reissuing a ticket when the user has not received the second data carrier distributed to the user according to the reservation of the reserved seat; means for obtaining reception information indicating whether the user has received the second data carrier distributed to the user according to the reservation of the reserved seat; and means for storing identification information of the ticket in the nonarrival database as the nonarrival information when it is determined based on the reception information that the user has not received the second data carrier. By having such a configuration, even when the second data carrier has not distributed to the user, it is possible to reissue the ticket appropriately.

It is also advantageous that the ticket use system includes: a nonarrival database for storing nonarrival information confirmed for reissuing a ticket when the user has not received the second data carrier distributed to the user according to the reservation of the reserved seat; means for obtaining reception information indicating whether the user has received the second data carrier distributed to the user according to the reservation of the reserved seat; and means for storing the first identification information in the nonarrival database as the nonarrival information when it is determined based on the reception information that the user has not received the second data carrier. By having such a configuration, even when the second data carrier has not distributed to the user, it is possible to issue the ticket appropriately by authenticating the first identification information which is stored in the first data carrier and which was distributed to the user in advance as the first identification information stored in the nonarrival database when the ticket is reissued.

It is also desirable that the ticket use system includes means for transmitting seat information of the ticket to a terminal of the user when it is determined based on the reception information that the user has not received the second data carrier. By having such a configuration, the user can recognize the seat information of the ticket without the second data carrier.

It is also desirable that the first data carrier and the second data carrier are composed of IC tags. It is also preferable that the first data carrier is attached to a strap attached to a cellular phone and the second data carrier is embedded in a printable card.

A ticket use system according to another aspect of the present invention is a ticket use system having a first IC tag, a second IC tag, and a server, the first IC tag being distributed to a user in advance and storing first identification information, the second IC tag being distributed to the user for each seat according to a reservation of a reserved seat, displaying reservation information, and storing second identification information, and the server communicatively connected to a user's cellular phone through a network, the ticket use system executing an authentication based on the first identification information stored in the first IC tag and the second identification information stored in the second IC tag by using the first IC tag and the second IC tag as tickets at an event venue, the server including: a ticket database for storing at least ticket authentication information used for authenticating the tickets at the event venue; means for receiving seat type information from the user's cellular phone through the network; means for storing the first identification information in the ticket database as the ticket authentication information when the received seat type information represents a nonreserved seat; and means for storing the second identification information in the ticket database as the ticket authentication information when the received seat type information represents a reserved seat.

A ticket use system according to another aspect of the present invention is a ticket use system having a first IC tag, a second IC tag, and a server, the first IC tag being distributed to a user in advance and storing first identification information, the second IC tag being distributed to the user for each seat according to a reservation of a reserved seat, displaying reservation information, and storing second identification information, and the server communicatively connected to a user's cellular phone through a network, the ticket use system executing an authentication based on the first identification information stored in the first IC tag and the second identification information stored in the second IC tag by using the first IC tag and the second IC tag as tickets at an event venue, the server including: a nonarrival database for storing nonarrival information confirmed for reissuing a ticket when the user has not received the second data carrier distributed to the user according to the reservation of the reserved seat; means for receiving reception information indicating whether the user has received the second data carrier from the user's cellular phone; and means for storing identification information of the ticket in the nonarrival database as the nonarrival information when it is determined based on the received reception information that the user has not received the second data carrier.

A ticket use system according to another aspect of the present invention is a ticket use system having a first IC tag, a second IC tag, and a server, the first IC tag being distributed to a user in advance and storing first identification information, the second IC tag being distributed to the user for each seat according to a reservation of a reserved seat, displaying reservation information, and storing second identification information, and the server communicatively connected to a user's cellular phone through a network, the ticket use system executing an authentication based on the first identification information stored in the first IC tag and the second identification information stored in the second IC tag by using the first IC tag and the second IC tag as tickets at an event venue, the server including: a nonarrival database for storing nonarrival information confirmed for reissuing a ticket when the user has not received the second data carrier distributed to the user according to the reservation of the reserved seat; means for receiving reception information indicating whether the user has received the second data carrier from the user's cellular phone; and means for storing the first identification information in the nonarrival database as the nonarrival information when it is determined based on the received reception information that the user has not received the second data carrier.

A ticket use method according to an aspect of the present invention is a ticket use method using a first data carrier and a second data carrier as tickets, the first data carrier being distributed to a user in advance and storing first identification information, and the second data carrier being distributed to the user according to a reservation of a reserved seat, displaying reservation information, and storing second identification information, the ticket use method including the steps of: obtaining seat type information input by the user; storing the first identification information in a ticket database as ticket authentication information used for authenticating the tickets when the obtained seat type information represents a nonreserved seat; and storing the second identification information in the ticket database as the ticket authentication information when the obtained seat type information represents a reserved seat.

Further, it is desirable that the ticket use method further includes a step of obtaining transaction completion information regarding a ticket fee and stores the first identification information or the second identification information in the ticket database when it is determined by the transaction completion information that the transaction of the ticket fee is completed.

It is also desirable that the ticket use method includes the steps of: obtaining reception information indicating whether the user has received the second data carrier distributed to the user according to the reservation of the reserved seat; and storing the second identification information in the ticket database when it is determined based on the reception information that the user has received the second data carrier.

It is also advantageous that the ticket use method includes the steps of: obtaining reception information indicating whether the user has received the second data carrier distributed to the user according to the reservation of the reserved seat; and storing identification information of the ticket as nonarrival information confirmed for reissuing a ticket when the user has not received the second data carrier when it is determined based on the reception information that the user has not received the second data carrier.

It is also desirable that the ticket use method includes the steps of: obtaining reception information indicating whether the user has received the second data carrier distributed to the user according to the reservation of the reserved seat; and storing the first identification information as nonarrival information confirmed for reissuing a ticket when the user has not received the second data carrier when it is determined based on the reception information that the user has not received the second data carrier.

A ticket use method according to another aspect of the present invention is a ticket use method for executing an authentication based on first identification information stored in a first IC tag and second identification information stored in a second IC tag by using the first IC tag and the second IC tag as tickets at an event venue, the first IC tag being distributed to a user in advance and storing the first identification information, and the second IC tag being distributed to the user for each seat according to a reservation of a reserved seat, displaying reservation information, and storing the second identification information, the method including the steps of: a control section of a server receiving seat type information from a user's cellular phone through a network; the control section of the server storing the first identification information in a ticket database as ticket authentication information used for authenticating the tickets at an event venue when the received seat type information represents a nonreserved seat; and storing the second identification information in the ticket database as the ticket authentication information when the obtained seat type information represents a reserved seat.

A ticket use method according to another aspect of the present invention is a ticket use method for executing an authentication based on first identification information stored in a first IC tag and second identification information stored in a second IC tag by using the first IC tag and the second IC tag as tickets at an event venue, the first IC tag being distributed to a user in advance and storing the first identification information, and the second IC tag being distributed to the user for each seat according to a reservation of a reserved seat, displaying reservation information, and storing the second identification information, the method including the steps of: a control section of the server receiving reception information indicating whether the user has received the second data carrier from the user's cellular phone; and storing identification information of the ticket in a nonarrival database as nonarrival information confirmed for reissuing a ticket when the user has not received the second data carrier when it is determined based on the received reception information that the user has not received the second data carrier.

A ticket use method according to another aspect of the present invention is a ticket use method for executing an authentication based on first identification information stored in a first IC tag and second identification information stored in a second IC tag by using the first IC tag and the second IC tag as tickets at an event venue, the first IC tag being distributed to a user in advance and storing the first identification information, and the second IC tag being distributed to the user for each seat according to a reservation of a reserved seat, displaying reservation information, and storing the second identification information, the method including the steps of: a control section of the server receiving reception information indicating whether the user has received the second data carrier from the user's cellular phone; and storing the first identification information in a nonarrival database as nonarrival information confirmed for reissuing a ticket when the user has not received the second data carrier when it is determined based on the received reception information that the user has not received the second data carrier.

### ADVANTAGES OF THE INVENTION

According to the present invention, it is possible to provide a ticket use system having a high safety and a high operability and suited to be put into practical use.

### BRIEF DESCRIPTION OF THE DRAWINGS

FIGS. 1A and 1B are system configuration diagrams of a ticket use system according to the present invention;

FIG. 2 is a diagram showing a database in the ticket use system according to the present invention;

FIGS. 3A to 3E are diagrams showing a data example stored in a database in the ticket use system according to the present invention;

FIG. 4 is a flow chart showing a whole process in the ticket use system according to the present invention;

FIGS. 5A and 5B are flow charts showing a ticket reservation process in the ticket use system according to the present invention;

FIGS. 6A and 6B are flow charts showing processes of a reservation confirmation and a transaction in the ticket use system according to the present invention;

FIG. 7 is a flow chart showing a ticket issuing process in a case when a card tag has not distributed to a user in the ticket use system according to the present invention; and

FIG. 8 is a flow chart showing an admission process in the ticket use system according to the present invention.

### DESCRIPTION OF REFERENCE NUMERALS

| | |
|---|---|
| 1 | SERVER (TICKET USE SYSTEM) |
| 2 | USER'S CELLULAR PHONE |
| 3 | NETWORK |
| 4 | CARD TAG |
| 5 | READER |
| 6 | RECEPTION TERMINAL |
| 11 | CPU (CONTROL SECTION) |
| 12 | STORAGE SECTION |
| 13 | COMMUNICATION CONTROL SECTION |
| 14 | RAM |
| 15 | DATABASE |
| 21 | STRAP TAG |
| 151 | USER INFORMATION DB |
| 152 | USER HISTORY DB |
| 153 | TICKET DB |
| 154 | RESERVATION DB |
| 155 | NONARRIVAL DB |

### BEST MODES FOR CARRYING OUT THE INVENTION

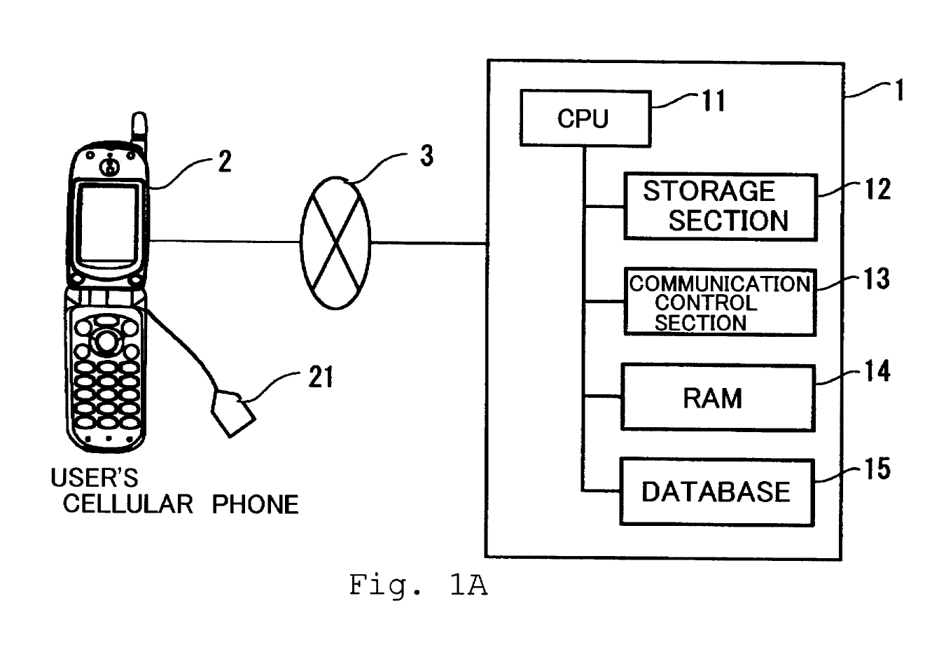

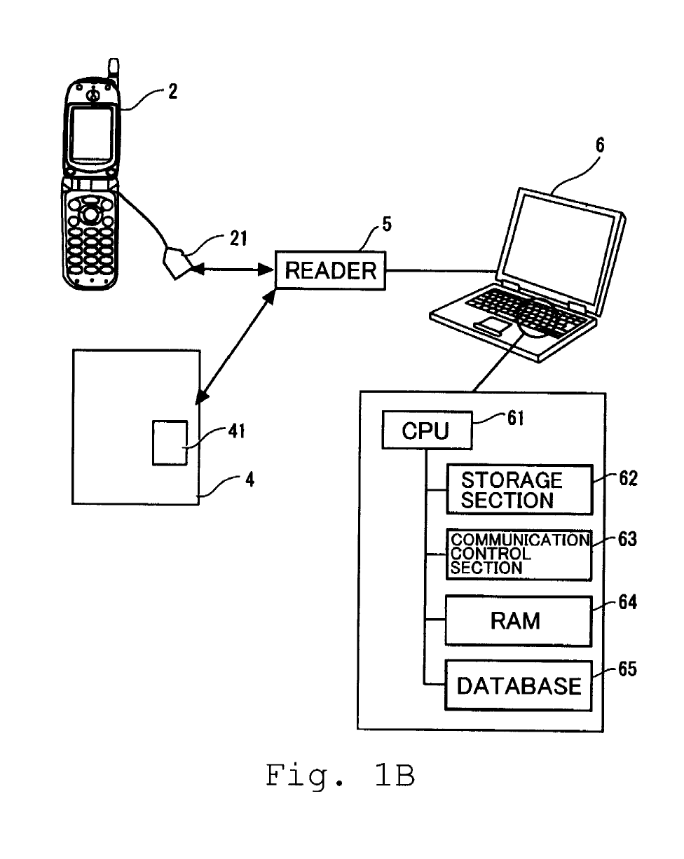

A configuration of a ticket use system according to the present invention will be described with reference to FIGS. 1A and 1B. FIG. 1A shows a configuration example of a system in which a user performs a reservation, a reservation confirmation, and a transaction of a ticket through a user's cellular phone. FIG. 1B shows a configuration example of a system which is placed at an event venue and performs an authentication of an admission. As shown, the ticket use system in a broad sense includes a server 1, a user's cellular phone 2, a network 3, a card tag 4, a reader 5, and a reception terminal 6. The server 1 is communicatively connected to the user's cellular phone 2 through the network 3. The reader 5 is wirelessly communicated with a cellular phone strap of IC tag 21 (hereinafter simply referred to as strap tag 21) attached to the user's cellular phone 2 or the card tag 4. In addition, the reader 5 is communicatively connected to the reception terminal 6. Note that the server 1 and the reception terminal 6 may be communicatively connected to each other through the network 3.

The server 1 is composed of a computer and builds the ticket use system in a narrow sense. The server 1 includes a hardware configuration such as a CPU 11, a storage section 12, a communication control section 13, an RAM 14, and a database 15. The server 1 also includes an output device such as a display and an input device such as a keyboard and mouse, but their illustration is omitted here.

The CPU 11 of the server 1 functions as a control section performing various processes based on an OS program and application program stored in the storage section 12 in advance.

The storage section 12 is composed of an internal storage means such as an EEP-ROM and hard disk and an external storage means such as a flexible disk and CD-ROM, and stores programs such as an OS program and application program. The application program in this example includes a software program creating a web data (web engine) and various other software programs for performing processes such as a ticket reservation, a reservation confirmation, and a transaction.

The communication control section 13 includes a communication interface to the network 3 and a communication control circuit. The communication control section 13 makes it possible to perform a data communication with the user's cellular phone 2.

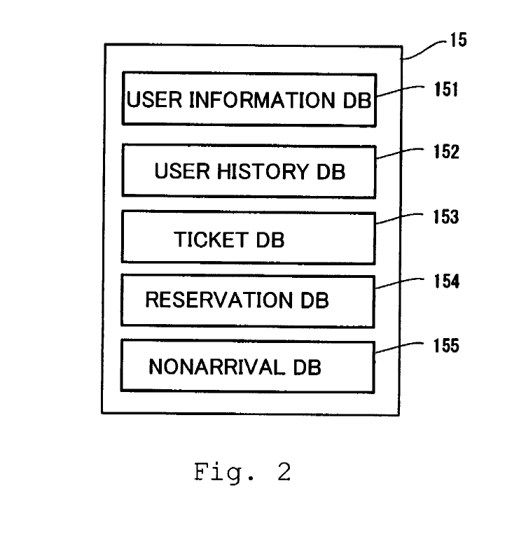

The RAM 14 is used as a work area of the CPU 11. For example, the RAM 14 temporarily stores an executing section of the program and the data used during the execution. The database 15 is composed of a storage means such as a hard disk and an optical disk. As shown in FIG. 2, the database (DB) 15 in this example includes a user information DB 151, a user history DB 152, a ticket DB 153, a reservation DB 154, and a nonarrival DB 155.

Note that the server 1 according to the embodiment of the present invention may be composed of a plurality of computers as well as a single computer. The hardware configuration of the server 1 is not limited to the configuration shown in FIGS. 1A and 1B. The server 1 may also include other servers such as a firewall server and other hardware configurations.

The cellular phone 2 is used by the user and is accessible to the Internet. It includes a CPU, an ROM, an RAM, an input means such as an input key, and an output means such as a small-sized display. The user's cellular phone 2 has a browser program stored in the memory, which makes it possible to receive a web data transmitted by the server 1 and to display the received data on the display. In the ticket use system according to the present invention, it is possible to use various other terminals such as a personal computer (PC) and a portable terminal instead of using the cellular phone 2.

The strap tag 21 which functions as a first carrier is attached to the cellular phone 2. The IC tag embedded in the strap tag 21 is a non-contact IC tag and is also called an RFID (Radio Frequency Identification) or a non-contact data carrier. The IC tag is a small-sized device which has a combination of a small IC chip storing information and an antenna for wireless communication. The data can be read out from the IC tag and written into the IC tag by electrical wave or electromagnetic wave using a reader and a reader writer. The memory embedded in the IC tag of the strap tag 21 stores at least a tag ID which is identification information of the tag. As will be described later in detail, the strap tag 21 has been distributed to the user according to a membership registration of the user. The strap tag 21 is used for admission confirmation when the user made the reservation of a nonreserved seat and for ticket issuing when the card tag 4 has not distributed to the user.

The network 3 is the one for a cellular phone, the Internet, a public network, and so on.

Referring to FIG. 1B, as an example, the card tag 4 which functions as a second data carrier is formed by holding an IC tag 41 between a reservation card made of two printable paper substrates and then bonding them by an adhesive. A memory embedded in the IC tag 41 of the card tag 4 stores at least a tag ID which is identification information of the tag. As will be described later in detail, the same number of the card tag 4 is issued as the reserved seat according to the reservation of the reserved seat and is distributed to the person who made the reservation. The card tag 4 is normally enclosed in the envelope and is mailed to the user. It is also possible to make a postcard by printing an address and a postal code on the reservation card and mail the postcard to the person who made the reservation. The card tag 4 is used for admission confirmation when the user who made the reservation of the reserved seat enters. Various information is printed on the reservation card such as a name of the event, event venue, date and hour, opening time, starting time, information of the reserved seat, fee, performer, organizer, contact info for inquiries, indication information regarding payment method of the ticket fee, access information for accessing the site regarding the ticket use system (URL information), mail address, number of payment slip, barcode, reception number, business code, number of order, and so on.

The reader 5 reads out the data, for example the tag ID, which is stored in the IC tag of the strap tag 21 or the card tag 4, and outputs the data to the reception terminal 6.

The reception terminal 6 is typically a computer terminal placed at the entrance of the event venue. The reception terminal 6 obtains the data such as the tag ID stored in the IC tag of the strap tag 21 or the card tag 4 through the reader 5, compares the obtained data with the ticket information that is stored in the ticket DB 153 and was previously obtained, and authenticates the data. The reception terminal 6 includes a hardware configuration such as a CPU 61, a storage section 62, a communication control section 63, an RAM 64, and a database 65. The reception terminal 6 also includes an output device such as a display and an input device such as a keyboard and mouse, but their illustration is omitted here. The configuration is basically the same as that of the server 1. The database 65 includes a user information DB 651, a user history DB 652, a ticket DB 653, a reservation DB 654, and a nonarrival DB 655. The information stored in each database is basically the same as the information stored in the database 15 of the server 1.

When the reception terminal 6 is connected to the server 1 through the network 3, the information of the database 65 installed on the reception terminal 6 may properly be obtained by accessing the server 1, or the information may be stored in the reception terminal 6 through an external storage media. Note that the information of the database 65 stored in the reception terminal 6 may not necessarily be the same as the information stored in the database 15 of the server 1. It is enough for the database 65 to store the information stored in the database 15 which is only necessary for the event.

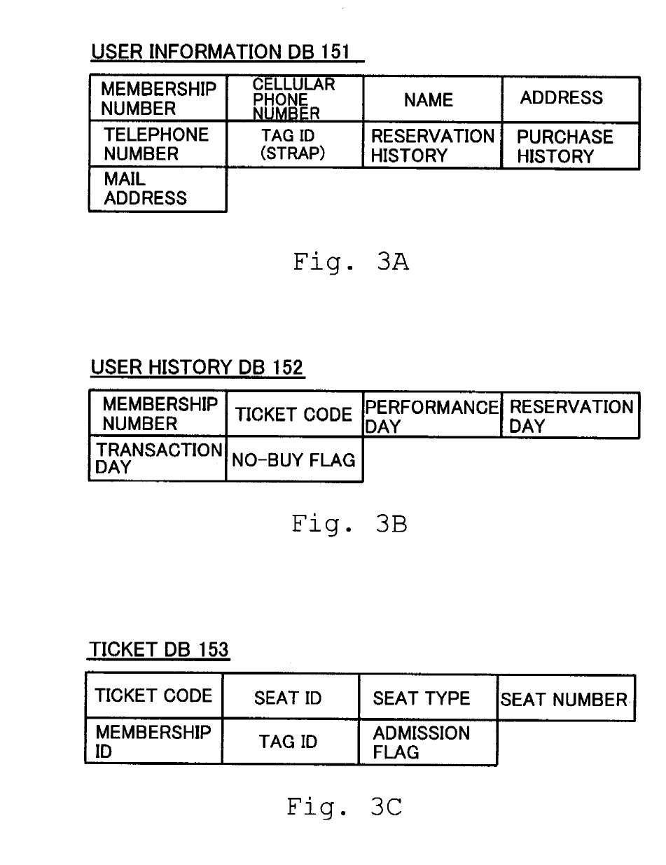

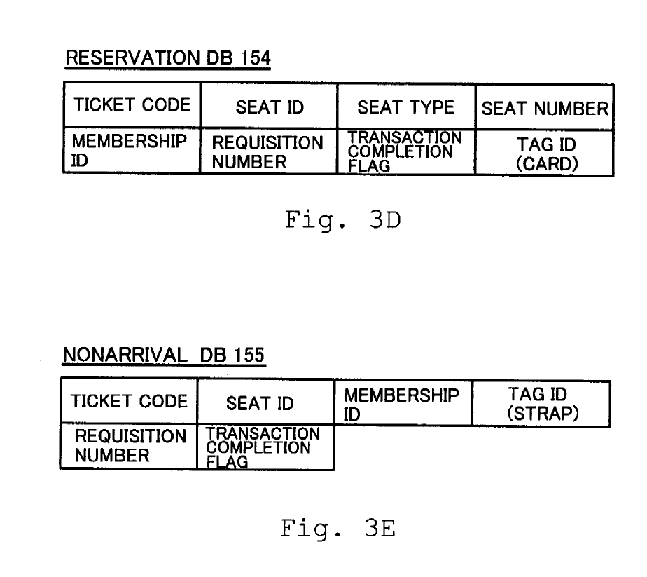

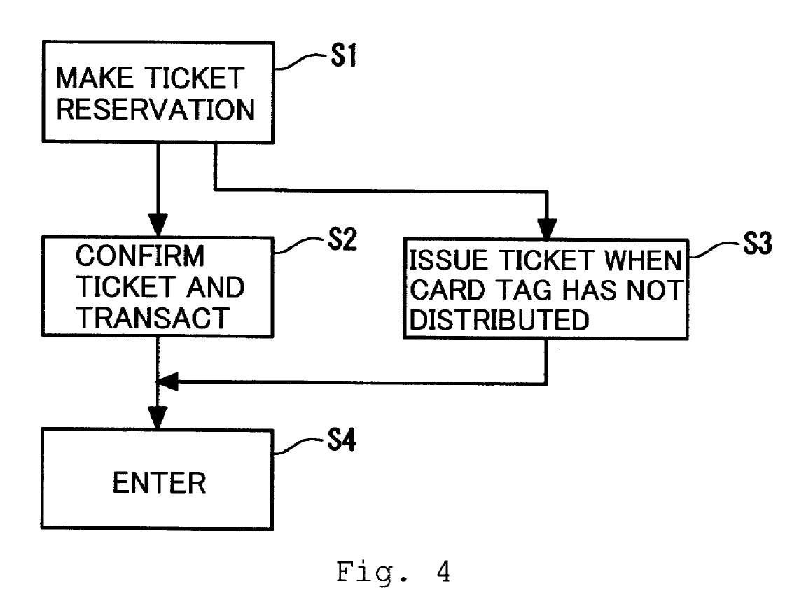

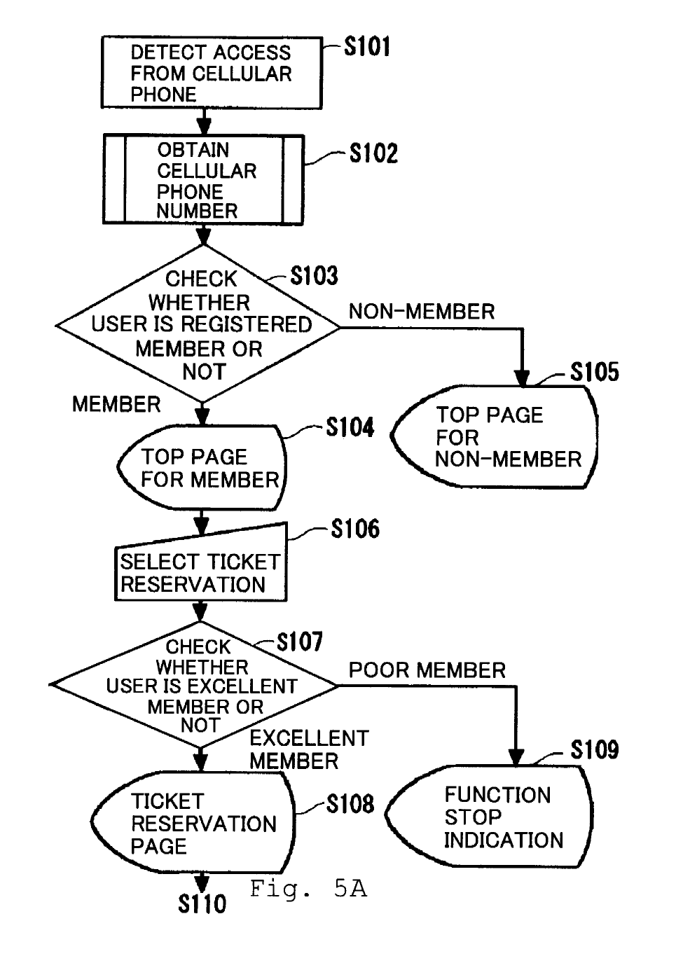

Referring now to FIGS. 3A to 3E, the information stored in the database 15 of the server 1 will be described. As shown in FIG. 3A, the user information DB 151 stores the information such as a membership number which is identification information of the member, a cellular phone number which is identification information of the cellular phone, user's name, address, telephone number, the tag ID which is identification information of the strap tag 21 distributed to the user according to the membership registration, reservation history information of the user, and ticket purchase history information of the user.

The user history DB 152 stores the membership number, a ticket code identifying the ticket, performance day indicating the day that the event is held, reservation day that the reservation is completed, transaction day that the transaction of the ticket fee is completed, and a no-buy flag indicating whether the user have had a predetermined times of experience before (for example, twice) that the user had made the reservation of the ticket and ended up not buying the ticket. The no-buy flag is referred to when a determination is made whether the user who makes the reservation is an excellent member or a poor member. When it is determined that the user is the poor member, the reservation cannot be accepted.

The ticket DB 153 stores ticket authentication information used to authenticate the ticket. Specifically, the ticket DB 153 stores the information such as the ticket code, a seat ID which is the identification information of the seat, a seat type information indicating if the seat is a nonreserved seat or reserved seat, a seat number identifying the seat, a membership ID of the user who bought the ticket, the tag ID, and an admission flag. As a rule, the tag ID is the one of the strap tag 21 when the user made the reservation of the nonreserved seat, and the tag ID is the one of the card tag 4 when the user made the reservation of the reserved seat. However, even when the seat is the reserved one, the tag ID of the strap tag 21 is stored when the card tag 4 has not distributed to the user. The admission flag is flag information indicating whether the user entered the event venue.

The reservation DB 154 stores the information such as the ticket code, the seat ID, the seat type, the seat number, the membership ID of the user who made the reservation, a requisition number which is the identification information of a requisition regarding the ticket fee charged to the user according to the ticket reservation, a transaction completion flag indicating whether the transaction of the ticket fee is completed, and the tag ID of the card tag 4.

The nonarrival DB 155 stores nonarrival information identifying the ticket and the user when the card tag 4 was mailed to the user to issue the ticket of the reserved seat but ended up not be distributed to the user, in other words the card tag 4 was nonarrival. Specifically, the nonarrival DB 155 stores the information such as the ticket code identifying the ticket which was nonarrival, the seat ID identifying the seat of the ticket which was nonarrival, the membership ID identifying the user who reserved the ticket and must have obtained the ticket, a requisition number regarding the fee of the ticket which was nonarrival, and a transaction completion flag indicating whether the transaction regarding the fee of the ticket which was nonarrival is completed.

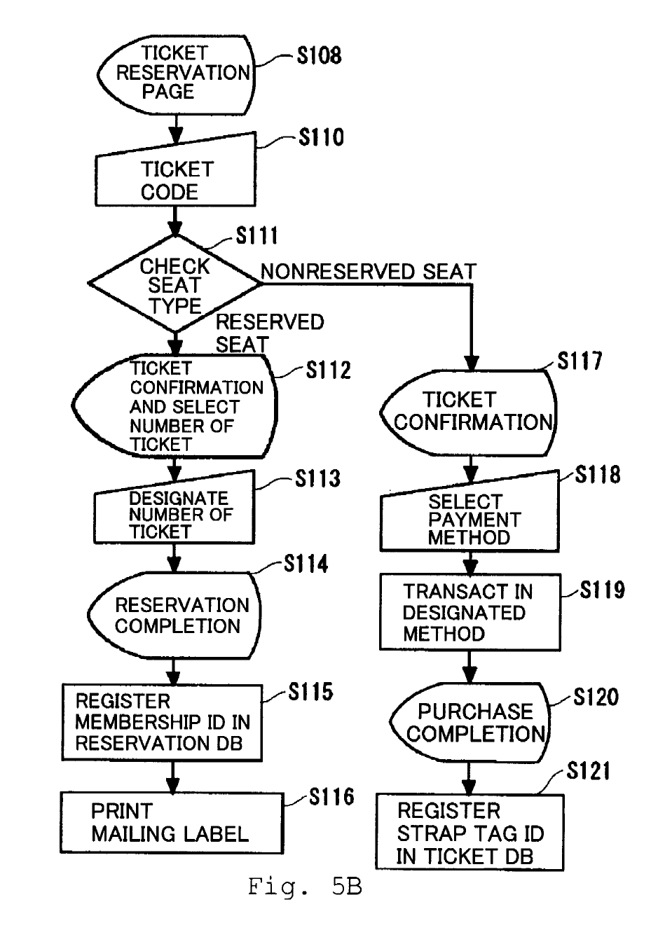

Referring now to the flow chart in FIG. 4, a summary of a process of the ticket use system according to the present invention will be described. The strap tag 4 is distributed to the user in advance. The user signs up for the ticket use system and then makes the reservation of the ticket through the cellular phone 2 (S1).

Then, the user performs the process of the ticket confirmation and the transaction through the cellular phone 2 (S2). In the ticket use system according to the present invention, the card tag 4 displaying the reservation information is mailed to the user when the user made the reservation of the reserved seat. Even when the user made the reservation of the reserved seat, the card tag 4 sometimes may not be distributed to the user by some slip-up. In such a case, a process for issuing the ticket is performed (S3). When the user made the reservation of the nonreserved seat, the strap tag 21 functions as the ticket.

When the user made the reservation of the nonreserved seat, the user holds the strap tag 21 which was distributed in advance over the reader 5 which is placed at the entrance of the event venue. When the user made the reservation of the reserved seat and has received the card tag 4, the user holds the card tag 4 over the reader 5. On the other hand, when the user made the reservation of the reserved seat but has not received the card tag 4, the user holds the strap tag 21 over the reader 5. The reception terminal 6 reads out the tag ID from these tags 4 and 21 through the reader 5 and checks the visitor by matching with the tag ID stored in the ticket DB 653 (S4).

As stated above, when the user made the reservation of the nonreserved seat, the strap tag 21 which was distributed in advance is used as the ticket. Therefore, there is no need to mail the tag used as the ticket each time the reservation is made, which makes it possible to reduce the burden of a ticket issuer. When the user made the reservation of the reserved seat, the card tag 4 displaying the reservation information is used as the ticket. Therefore, the user can easily recognize the reservation information by just checking the card tag 4 and can easily grasp the content of the ticket. It is also convenient when the user tries to find the seat at the event venue.

Referring now to flow charts in FIGS. 5A and 5B, the ticket reservation will be described in detail. First, the user accesses the site for the ticket reservation through the user's cellular phone 2. In this case, the server 1 detects the access from the user's cellular phone 2 (S101). Specifically, the control section composed of the CPU 11 of the server 1 detects the access. The control section of the server 1 obtains the cellular phone number included in the information transmitted from the cellular phone 2 in accordance with the detection of the access (S102).

The control section of the server 1 refers to the user information DB 151 based on the obtained cellular phone number and determines whether the user's cellular phone 2 that accessed the site is the one of the registered member (S103). Specifically, the control section of the server 1 determines if the obtained cellular phone number is included in the cellular phone number of the member stored in the user information DB 151. When the control section of the server 1 determines that the obtained cellular phone number is not included in the cellular phone number of the member stored in the user information DB 151, it is determined that the access is made from a non-member. Then the control section of the server 1 transmits to the user's cellular phone 2 the web page which is the top page for the non-member and which was previously made for the non-member (S105). The user's cellular phone 2 receives the web page which is the top page for the non-member and displays the top page for the non-member on the display. As long as the user is the non-member, the user cannot reserve the ticket using the ticket use system, so there is no further process available. The user can reserve the ticket using the ticket use system by executing the membership registration.

On the other hand, when it is determined that the obtained cellular phone number is included in the cellular phone number of the member stored in the user information DB 151, the determination is made that the access is made from the member. Then the control section of the server 1 transmits to the user's cellular phone 2 the web page which is the top page for the member and which was previously made for the member (S104). The user's cellular phone 2 receives the web page which is the top page for the member and displays the top page for the member on the display. In the top page for the member, the menu such as the ticket reservation, a ticket confirmation and payment, a ticket search, the transaction method, and an additional service is displayed.

Then the user checks the top page for the member displayed on the cellular phone 2, and selects and inputs the ticket reservation (S106). The selected information indicating that the user selected the ticket reservation is transmitted to the server 1 through the user's cellular phone 2. The control section of the server 1 receives the selected information and then determines if the user verified as the member is an excellent member or not (S107). Specifically, the control section of the server 1 searches the user history DB 152 based on the membership number identified based on the cellular phone number by the user information DB 151 and refers to the no-buy flag regarding the membership number. The no-buy flag is the information indicating whether the user have had a predetermined times of experience that the user had made the reservation of the ticket and ended up not buying the ticket. It is determined that the user is the poor member when the number is more than the predetermined times. On the other hand, it is determined that the user is the excellent member when the number is less than the predetermined times. When the control section of the server 1 determines by the no-buy flag that the member is the poor member, the web page is transmitted to the user's cellular phone 2 showing that the function is stopped and that the user cannot get the ticket reservation service (S109). The user's cellular phone 2 receives the web page showing that the function is stopped and displays the content on the display.

On the other hand, when the control section of the server 1 determines by the no-buy flag that the member is the excellent member, the web page for displaying the ticket reservation page is transmitted to the user's cellular phone 2 (S108). The user's cellular phone 2 receives the web page and displays the ticket reservation page on the display. In the ticket reservation page, an input box for inputting the ticket code and a message helping the input are displayed.

The user inputs the ticket code into the input box of the ticket reservation page (S110). The ticket code information is transmitted to the server 1 from the user's cellular phone 2. The control section of the server 1 receives the ticket code information and determines the seat type indicating if the seat is the nonreserved seat or the reserved seat based on the received ticket code information (S111). Specifically, the control section of the server 1 determines the seat type only from the ticket code when the ticket code itself includes any information such as a code indicating the seat type. On the other hand, the control section of the server 1 determines the seat type by referring to the ticket DB 153 when the ticket code itself does not include any information indicating the seat type.

When the control section of the server 1 determines that the ticket that the user is trying to reserve is the reserved seat, the control section of the server 1 transmits to the user's cellular phone 2 that accessed the site the reservation confirmation information for confirming the reservation content and the web page which is the ticket confirmation page displaying the message for helping the user to select the number of ticket that the user is trying to reserve (S112). The user's cellular phone 2 receives the web page which is the ticket confirmation page and displays the ticket confirmation page on the display. As an example, the ticket confirmation page displays the reservation content and the input box for inputting the number of ticket that the user is trying to reserve.

The user checks the ticket confirmation page and puts the number of ticket into the input box for inputting the number of ticket that the user is trying to reserve (S113). The information regarding the number of ticket is transmitted to the server 1 from the user's cellular phone 2. The control section of the server 1 receives the information regarding the number of reserved ticket. When the user made the reservation of more than two tickets, the control section of the server 1 assigns the sequential number so that the user can have the seats next to one another. In this case, a module is preferably used for assigning the seats which were reserved at the same time will be next to one another according to a seat placement at the event venue. When the user made the reservation of only one ticket, no special assignment process is performed. The control section of the server 1 performs the process according to the registration of the information of the number of reserved ticket, and then transmits to the user's cellular phone 2 the web page which is a reservation complete page. The user's cellular phone 2 receives the web page and displays the reservation complete page on the display.

With the completion of the reservation, the control section of the server 1 stores the information regarding this reservation in the user history DB 152 and the reservation DB 154 (S115). Specifically, the control section of the server 1 stores in the user history DB 152 such information as the membership number of the user who made the reservation, the ticket code of the reserved ticket, the day of the performance of the reserved event, and the day when the reservation is completed. The control section of the server 1 also stores in the reservation DB 154 such information as the ticket code of the reserved ticket, the seat ID of the reserved seat, the seat type (the reserved seat in this case), the seat number of the reserved seat, and the membership number of the user who made the reservation.

With the completion of the reservation, the control section of the server 1 assigns the card tag distributed to each of the member who made the reservation of the reserved seat. Specifically, the control section of the server 1 assigns any card tag 4 of the card tag 4 prepared in advance to each of the ticket, correlates the tag ID of the assigned card tag 4 to the ticket code, and stores the tag ID in the reservation DB 154.

Then a printing process of the mailing label for mailing the card tag 4 assigned to the ticket that completed the reservation of the reserved seat (S116). Specifically, the control section of the server 1 identifies the user who completed the reservation by the membership ID correlated to the ticket code in the reservation DB 154 according to the completion of the reservation. Then the control section of the server 1 reads out the corresponding name and address from the user information DB 151 based on the membership ID and prints the mailing label. When the card tag 4 is a postcard, the name and address may be printed on the paper surface of the card tag 4. Then the reservation of the reserved seat is completed, and the card tag 4 is mailed to the user who made the reservation of the reserved seat. In this stage, the transaction is not completed and the card tag 4 does not function as a ticket. Because the card tag 4 is not paper money, it is possible to mail the card tag 4 in a simple and convenient way when the card tag 4 is mailed.

When the control section of the server 1 determines that the ticket that the user is trying to reserve is the nonreserved seat (S111), the control section of the server 1 transmits to the user's cellular phone 2 the web page which is the ticket confirmation page displaying the reservation confirmation information for confirming the reservation content (S117). The user's cellular phone 2 receives the web page which is the ticket confirmation page and displays the ticket confirmation page on the display. When the user made the reservation of the nonreserved seat, the strap tag 21 distributed to each user according to the membership registration functions as the ticket. A payment method for the ticket fee is listed in the ticket confirmation page and a message is displayed for helping the user to select the particular payment method. The payment method includes a cash payment at a convenience store, a payment by a credit card, and a payment by electric money, for example.

The user checks the ticket confirmation page, and selects and inputs the payment method (S118). The selected information of the payment method is transmitted to the server 1 from the user's cellular phone 2. The control section of the server 1 receives the selected information of the payment method and stores the information in the predetermined storage device. When the transaction is performed in a way the user designated (S119), the control section of the server 1 transmits to the user's cellular phone 2 the web page which is the page indicating the completion of the ticket purchasing according to the transaction completion (S120). The user's cellular phone 2 receives the web page and displays the purchase completion page on the display.

With the completion of the ticket purchasing, the control section of the server 1 reads out from the user information DB 151 the tag ID of the strap tag 21 corresponding to the membership ID identifying the member who purchased the ticket, correlates the tag ID which is read out to the ticket code and the membership ID, and stores the tag ID in the ticket DB 153 (S121). Thus the reservation and the transaction when the user made the reservation of the nonreserved seat are completed.

As explained above, in the present invention, the ticket reservation is made through the cellular phone and the individual information of the cellular phone is obtained, which makes it possible to prevent a malicious mischief that someone makes the reservation of the ticket even though the person has no intention of purchasing the ticket.

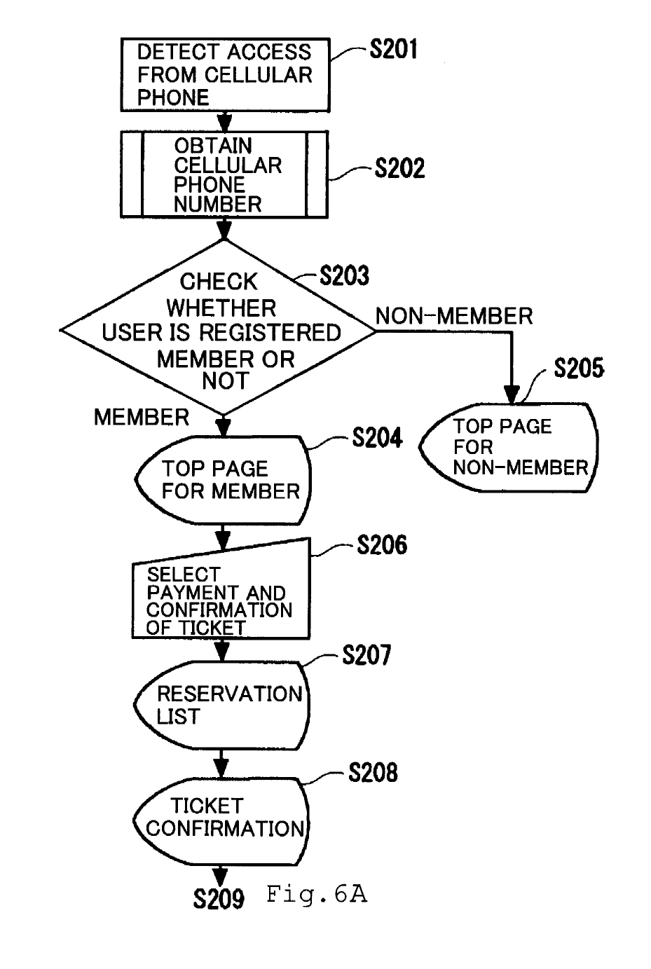

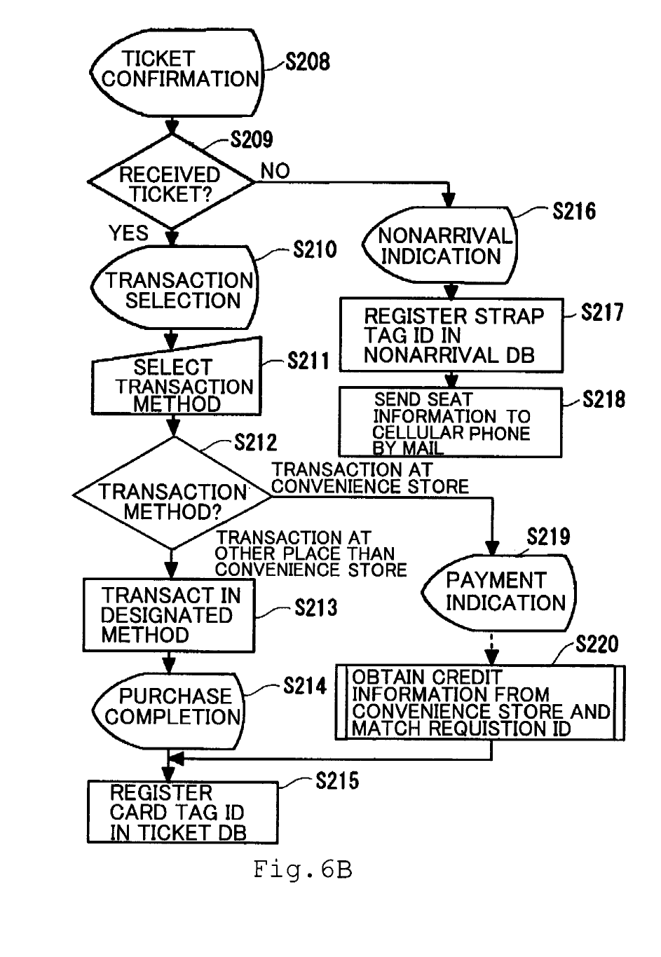

Referring now to flow charts in FIGS. 6A and 6B, the reservation confirmation and the transaction when the user made the reservation of the reserved seat will be described. When the user made the reservation of the reserved seat, the card tag 4 is mailed to the user, as mentioned above. The card tag 4 embeds the IC tag 41 storing the tag IC. Various information is printed on the surface of the card tag 4 such as the name of the event, event venue, date and hour, opening time, starting time, information of the reserved seat, fee, performer, organizer, contact info for inquiries, indication information regarding payment method of the ticket fee, access information for accessing the site regarding the ticket use system (URL information), mail address, number of payment slip, barcode, reception number, business code, number of order, and so on. A portion of an area that embeds the IC tag 41 may be printed so as to be surrounded by perforation line. The user may treat the whole card tag 4 as a ticket, but the user may cut off the card tag 4 in perforation line and make the ticket smaller.

The user accesses the access information printed on the card tag 4 through the cellular phone 2. In this case, the control section of the server 1 detects the access from the user's cellular phone 2 (S201). The control section of the server 1 obtains the cellular phone number included in the information transmitted from the cellular phone 2 according to the detection of the access (S202).

The control section of the server 1 refers to the user information DB 151 based on the obtained cellular phone number and determines whether the user's cellular phone 2 that accessed the site is the one of the registered member (S203). When the control section of the server 1 determines that the obtained cellular phone number is not included in the cellular phone number of the member stored in the user information DB 151, the determination is made that the access is made from a non-member. Then the control section of the server 1 transmits to the user's cellular phone 2 the web page which is the top page for the non-member and which was previously made for the non-member (S205). The user's cellular phone 2 receives the web page which is the top page for the non-member and displays the top page for the non-member on the display.

On the other hand, when it is determined that the obtained cellular phone number is included in the cellular phone number of the member stored in the user information DB 151, the determination is made that the access is made from the member. Then the control section of the server 1 transmits to the user's cellular phone 2 the web page which is the top page for the member and which was previously made for the member (S204). The user's cellular phone 2 receives the web page which is the top page for the member and displays the top page for the non-member on the display.

The user checks the displayed top page for the member, and selects and inputs the payment and confirmation of the ticket (S206). The user's cellular phone 2 transmits to the server 1 the information regarding the payment and confirmation that was selected and input. The control section of the server 1 performs the process of making the reservation list according to the reception of the information regarding the payment and confirmation that was selected and input (S207). Specifically, the control section of the server 1 reads out from the user history DB 152 the ticket (event) information reserved by the user before by the membership ID identified by the user information DB 151 based on the cellular phone number of the cellular phone 2. And the control section of the server 1 makes the reservation list based on the information which is read out. The reservation list may include various information such as the ticket code, the day of the performance, and the day of the reservation. The reservation list may also include the information such as the event name and the performer. The control section of the server 1 creates the web page for displaying the reservation list and transmits the web page to the user's cellular phone 2 (S207). The user's cellular phone 2 receives the web page formed of the reservation list and displays the reservation list on the display.

When the user selects and inputs the particular reservation ticket included in the reservation list displayed on the display, the selected information is transmitted to the server 1 from the user's cellular phone 2. The control section of the server 1 reads out the information such as the seat ID, the seat type, the seat number, and the requisition number from the reservation DB 154 according to the selected information, creates the web page which is the ticket confirmation page displaying such information, and transmits the web page to the user's cellular phone 2 (S208). The user's cellular phone 2 receives the web page which is the ticket confirmation page and displays the ticket confirmation page on the display.

When the user checks the ticket confirmation page and has received the card tag 4 of the displayed ticket, the user confirms and inputs the information that the user has received the card tag 4. When the user has not received the card tag 4, in other words when the card tag has not distributed, then the information is input that the card tag has not distributed (S209). The reception information which was input is transmitted to the server 1 from the user's cellular phone 2. The control section of the server 1 responds to the reception information. When the reception information indicates that the user has received the card tag 4, the control section of the server 1 transmits to the user's cellular phone 2 the web page displaying the transaction selection page for selecting the transaction method (S210). The user's cellular phone 2 receives the web page which is the transaction selection page and displays the transaction selection page on the display. In the transaction selection page, the choice of transaction method, which is the payment method for the ticket fee, is displayed as well as the information identifying the event. In this example, the payment method includes the payment at the convenience store, the payment by electrical money, and the payment by the credit card.

The user selects and inputs the transaction method. The user's cellular phone 2 transmits to the server 1 the selected information of the transaction method according to the input information. When the user did not select the payment at the convenience store and selected the payment by the electrical money or the credit card, the control section of the server 1 and the user exchange further information to transact through the cellular phone 2 (S213). In accordance with the completion of the transaction process, the control section of the server 1 transmits to the user's cellular phone 2 the web page displaying the purchase completion page indicating the purchase completion (S214). The user's cellular phone 2 receives the web page which is the purchase completion page and displays the purchase completion page on the display.

When the user selected the payment at the convenience store, the control section of the server 1 transmits to the user's cellular phone 2 the web page which is the payment indication page indicating the payment indication at the convenience store (S219). The user's cellular phone 2 receives the web page which is the payment indication page and displays the payment indication page on the display.

When the user pays for the ticket fee at the convenience store based on the payment information printed on the card tag 4, the credit information is created by a system at the convenience store. The control section of the server 1 obtains the credit information based on the requisition ID through the system at the convenience store (S220). When the ticket use system according to the present invention and the system at the convenience store are communicatively connected, information can be obtained through the network. On the other hand, when the two systems are not communicatively connected, information is input to the ticket use system from the system at the convenience store and the credit information based on the requisition ID is obtained from the input information.

When the transaction process and the ticket purchasing are completed, the control section of the server 1 correlates the tag ID of the card tag 4 distributed to the user to the ticket code, stores the tag ID in the reservation DB 154, and sets the transaction completion flag to the content indicating the transaction completion (S215). The control section of the server 1 correlates the tag ID of the card tag 4 distributed to the user to the ticket code and stores the tag ID in the ticket DB 153. Also the control section of the server 1 clears the no-buy flag stored in the user history DB 152 according to the transaction completion.

In the step for confirming whether the user has received the card tag 4 (S209), when the user inputs the information that the user has not received the card tag 4, the information is transmitted to the server 1 from the cellular phone 2. The control section of the server 1 receives the information that the user has not received the card tag 4 and, according to the reception of the nonarrival information, transmits to the user's cellular phone 2 the web page which is the nonarrival indication page displaying the indication message when the card tag 4 has not distributed (S216). The user's cellular phone 2 receives the web page which is the nonarrival indication page and displays the nonarrival indication page on the display. In the nonarrival indication page, the message is displayed such as “We will issue your ticket at the information desk at the event venue on the event day. Please don't forget to bring your cellular phone and the strap IC tag.”

The control section of the server 1 reads out the ticket code of the ticket which was not distributed, the seat ID, the membership ID, and the requisition number from the reservation DB 154, and stores these information in the nonarrival DB 155. The control section of the server 1 also reads out the tag ID of the strap tag 21 correlated to the membership ID by the user information DB 151, which is the tag ID of the strap tag 21 distributed to the member who reserved the ticket which was not distributed, correlates to the membership ID, and stores the tag ID in the nonarrival DB 155 (S217). Also the control section of the server 1 transmits the seat information including the seat ID and the seat number to the mail address stored in the user information DB 151 from the reservation DB 154 (S218). Thus the user can obtain the seat information even when the user has not received the card tag 4.

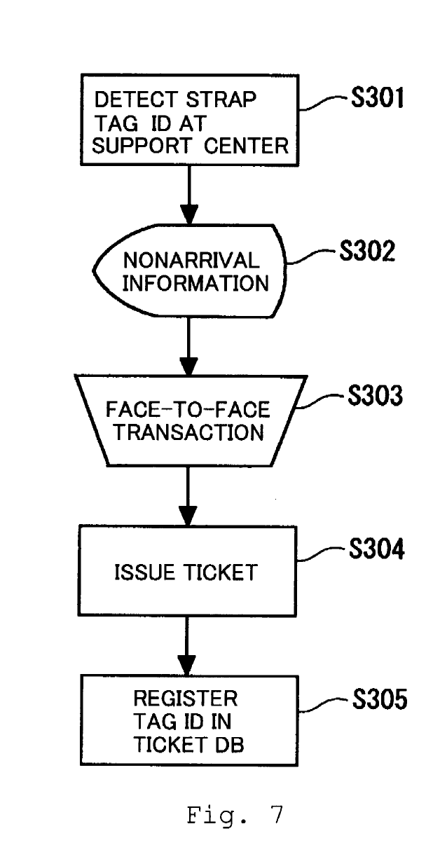

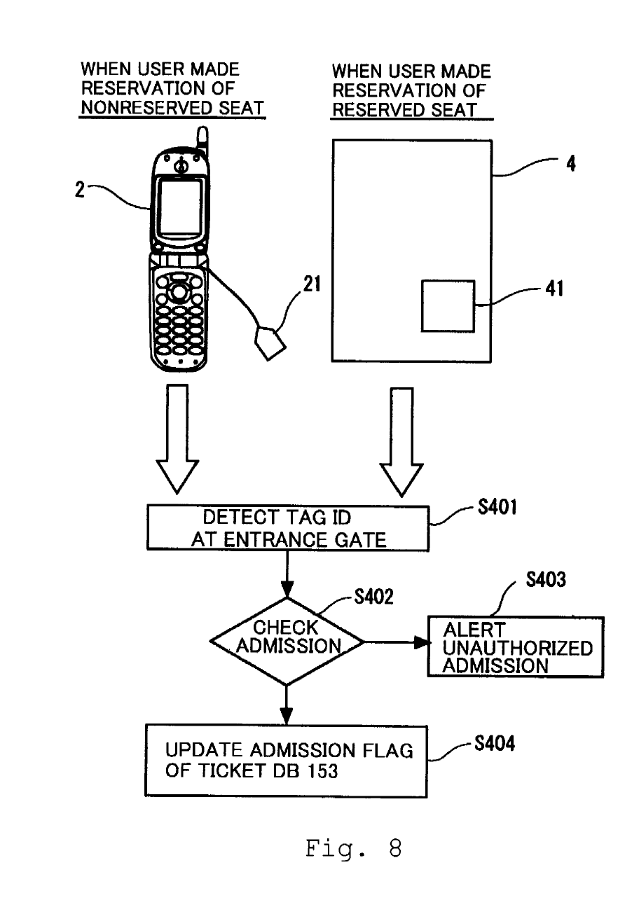

Referring now to a flow chart in FIG. 7, the ticket issuing process will be described when the card tag 4 which functions as the ticket of the reserved seat and which should have mailed to the user has not distributed to the user. In this example, a support center is set up at the event venue, and the reader and the terminal as shown in FIG. 1B are placed at the support center. The terminal is connected to the server 1 through the network. The terminal is preferably connected to the reception terminal 6 placed for the authentication of admission through the network. When the terminal and the reception terminal 6 are not connected to each other the data is exchanged through the external storage media. The terminal and the reception terminal 6 may be composed of a single computer.

The user brings the strap tag 21 which was distributed at the time of membership registration to the support center and holds the strap tag 21 over the reader 5. The terminal reads out the tag ID stored in the strap tag 21 through the reader (S301). The terminal searches the nonarrival DB 155 by the tag ID that was read out, reads out the nonarrival information (such as the ticket code, the seat ID, the membership ID, and the requisition number) which corresponds to the tag ID, and displays those information on the display of the terminal (S302). The operator of the terminal confirms the nonarrival information displayed on the display and performs the face-to-face transaction with the user (S303).

After the transaction is completed, the operator inputs the information that the transaction has been completed. The terminal performs the ticket issuing process according to the input that the transaction is completed (S304). When the terminal and the server 1 are connected to each other through the network, the transaction completion information is transmitted to the server 1 from the terminal. When the terminal and the server 1 are not connected to each other the terminal inputs the transaction completion information into the server 1. The control section of the server 1 correlates the tag ID stored in the strap tag 21 to the ticket code in accordance with the transaction completion information, stores the tag ID in the ticket DB 153, and registers the tag ID (S305). Likewise, the control section of the server 1 correlates the ID stored in the strap tag 21 to the ticket code, stores the ID in the ticket DB 653 of the reception terminal 6 placed at the entrance gate, and registers the ID.

Referring now to a flow chart in FIG. 8, the admission process will be described. As shown in FIG. 1B, the reader 5 and the reception terminal 6 are placed at the entrance.

The user holds the strap tag 21 over the reader 5 when the user made the reservation of the nonreserved seat and when the user made the reservation of the reserved seat but the card tag 4 was not distributed to the user. When the user made the reservation of the reserved seat, the user holds the mailed card tag 4 over the reader 5. The control section of the reception terminal 6 reads out by the reader 5 the tag ID stored in the strap tag 21 or the card tag 4 (S401).

Then the control section of the reception terminal 6 searches the ticket DB 653 and performs the matching process according to the tag ID which was read out (S402). When the tag ID which was read out is stored as the tag ID of the event stored in the ticket DB 653, the determination is made that the strap tag 21 or the card tag 4 functions as the authorized ticket of the event. Then the information that the strap tag 21 or the card tag 4 functions as the authorized ticket of the event is displayed on the display of the reception terminal 6. The control section of the reception terminal 6 recognizes the admission of the user and updates the admission flag of the ticket DB 653 (S404).

When the reception terminal 6 and the server 1 are connected to each other through the network, the reception terminal 6 may transmit to the server 1 the information needed for the matching process. Then the control section of the server 1 performs the matching process according to the information and sends the result to the reception terminal 6.

On the other hand, when the received tag ID is not stored as the tag ID of the event stored in the ticket DB 153, it is considered that the strap tag 21 or the card tag 4 does not function as the authorized ticket of the event, which means unauthorized admission, and then alert against the unauthorized admission is displayed on the display of the reception terminal 6 (S403).

### INDUSTRIAL APPLICABILITY

The present invention is applicable to a reservation of a ticket of a event, a reservation confirmation, and a transaction.

1-20. (canceled)

21. A ticket use system using a first data carrier and a second data carrier as tickets, the first data carrier being distributed to a user in advance and storing first identification information, and the second data carrier being distributed to the user according to a reservation of a reserved seat, displaying reservation information, and storing second identification information, the ticket use system comprising:
a ticket database for storing at least ticket authentication information used for authenticating the tickets;
portion for obtaining seat type information input by the user;
portion for storing the first identification information in the ticket database as the ticket authentication information when the obtained seat type information represents a nonreserved scat; and
portion for storing the second identification information in the ticket database as the ticket authentication information when the obtained seat type information represents a reserved seat.

22. The ticket use system according to claim 21, further comprising portion for obtaining transaction completion information regarding a ticket fee, characterized in that the first identification information or the second identification information is stored in the ticket database when it is determined by the transaction completion information that the transaction of the ticket fee is completed.

23. The ticket use system according to claim 21, comprising:
portion for obtaining reception information indicating whether the user has received the second data carrier distributed to the user according to the reservation of the reserved seat; and
portion for storing the second identification information in the ticket database when it is determined based on the reception information that the user has received the second data carrier.

24. The ticket use system according to claim 21, comprising:
a nonarrival database for storing nonarrival information confirmed for reissuing a ticket when the user has not received the second data carrier distributed to the user according to the reservation of the reserved seat;
portion for obtaining reception information indicating whether the user has received the second data carrier distributed to the user according to the reservation of the reserved seat; and
portion for storing identification information of the ticket in the nonarrival database as the nonarrival information when it is determined based on the reception information that the user has not received the second data carrier.

25. The ticket use system according to claim 21, comprising:
a nonarrival database for storing nonarrival information confirmed for reissuing a ticket when the user has not received the second data carrier distributed to the user according to the reservation of the reserved seat;
portion for obtaining reception information indicating whether the user has received the second data carrier distributed to the user according to the reservation of the reserved seat; and
portion for storing the first identification information in the nonarrival database as the nonarrival information when it is determined based on the reception information that the user has not received the second data carrier.

26. The ticket use system according to claim 24, comprising portion for transmitting seat information of the ticket to a terminal of the user when it is determined based on the reception information that the user has not received the second data carrier.

27. The ticket use system according to claim 21, characterized in that the first data carrier and the second data carrier are composed of IC tags.

28. The ticket use system according to claim 21, characterized in that the first data carrier is attached to a strap attached to a cellular phone.

29. The ticket use system according to claim 21, characterized in that the second data carrier is embedded in a printable card.

30. A ticket use system having a first IC tag, a second IC tag, and a server, the first IC tag being distributed to a user in advance and storing first identification information, the second IC tag being distributed to the user for each seat according to a reservation of a reserved seat, displaying reservation information, and storing second identification information, and the server communicatively connected to a user's cellular phone through a network, the ticket use system executing an authentication based on the first identification information stored in the first IC tag and the second identification information stored in the second IC tag by using the first IC tag and the second IC tag as tickets at an event venue, the server comprising:
a ticket database for storing at least ticket authentication information used for authenticating the tickets at the event venue;
portion for receiving seat type information from the user's cellular phone through the network;
portion for storing the first identification information in the ticket database as the ticket authentication information when the received seat type information represents a nonreserved seat; and
portion for storing the second identification information in the ticket database as the ticket authentication information when the received seat type information represents a reserved seat.

31. A ticket use system having a first IC tag, a second IC tag, and a server, the first IC tag being distributed to a user in advance and storing first identification information, the second IC tag being distributed to the user for each seat according to a reservation of a reserved seat, displaying reservation information, and storing second identification information, and the server communicatively connected to a user's cellular phone through a network, the ticket use system executing an authentication based on the first identification information stored in the first IC tag and the second identification information stored in the second IC tag by using the first IC tag and the second IC tag as tickets at an event venue, the server comprising:
a nonarrival database for storing nonarrival information confirmed for reissuing a ticket when the user has not received the second data carrier distributed to the user according to the reservation of the reserved seat;
portion for receiving reception information indicating whether the user has received the second data carrier from the user's cellular phone; and
portion for storing identification information of the ticket in the nonarrival database as the nonarrival information when it is determined based on the received reception information that the user has not received the second data carrier.

32. A ticket use system having a first IC tag, a second IC tag, and a server, the first IC tag being distributed to a user in advance and storing first identification information, the second IC tag being distributed to the user for each seat according to a reservation of a reserved seat, displaying reservation information, and storing second identification information, and the server communicatively connected to a user's cellular phone through a network, the ticket use system executing an authentication based on the first identification information stored in the first IC tag and the second identification information stored in the second IC tag by using the first IC tag and the second IC tag as tickets at an event venue, the server comprising:
a nonarrival database for storing nonarrival information confirmed for reissuing a ticket when the user has not received the second data carrier distributed to the user according to the reservation of the reserved seat;
portion for receiving reception information indicating whether the user has received the second data carrier from the user's cellular phone; and
portion for storing the first identification information in the nonarrival database as the nonarrival information when it is determined based on the received reception information that the user has not received the second data carrier.

33. A ticket use method using a first data carrier and a second data carrier as tickets, the first data carrier being distributed to a user in advance and storing first identification information, and the second data carrier being distributed to the user according to a reservation of a reserved seat, displaying reservation information, and storing second identification information, the ticket use method comprising:
obtaining seat type information input by the user;
storing the first identification information in a ticket database as ticket authentication information used for authenticating the tickets when the obtained seat type information represents a nonreserved seat; and
storing the second identification information in the ticket database as the ticket authentication information when the obtained seat type information represents a reserved seat.

34. The ticket use method according to claim 33, further comprising obtaining transaction completion information regarding a ticket fee, characterized in that the first identification information or the second identification information is stored in the ticket database when it is determined by the transaction completion information that the transaction of the ticket fee is completed.

35. The ticket use method according to claim 33, comprising:
obtaining reception information indicating whether the user has received the second data carrier distributed to the user according to the reservation of the reserved seat; and
storing the second identification information in the ticket database when it is determined based on the reception information that the user has received the second data carrier.

36. The ticket use method according to claim 33, comprising:
obtaining reception information indicating whether the user has received the second data carrier distributed to the user according to the reservation of the reserved seat; and
storing identification information of the ticket as nonarrival information confirmed for reissuing a ticket when the user has not received the second data carrier when it is determined based on the reception information that the user has not received the second data carrier.

37. The ticket use method according to claim 33, comprising:
obtaining reception information indicating whether the user has received the second data carrier distributed to the user according to the reservation of the reserved seat; and
storing the first identification information as nonarrival information confirmed for reissuing a ticket when the user has not received the second data carrier when it is determined based on the reception information that the user has not received the second data carrier.

38. A ticket use method for executing an authentication based on first identification information stored in a first IC tag and second identification information stored in a second IC tag by using the first IC tag and the second IC tag as tickets at an event venue, the first IC tag being distributed to a user in advance and storing the first identification information, and the second IC tag being distributed to the user for each seat according to a reservation of a reserved seat, displaying reservation information, and storing the second identification information, the method comprising:
a control section of a server receiving seat type information from a user's cellular phone through a network;
the control section of the server storing the first identification information in a ticket database as ticket authentication information used for authenticating the tickets at an event venue when the received seat type information represents a nonreserved seat; and
storing the second identification information in the ticket database as the ticket authentication information when the obtained seat type information represents a reserved seat.

39. A ticket use method for executing an authentication based on first identification information stored in a first IC tag and second identification information stored in a second IC tag by using the first IC tag and the second IC tag as tickets at an event venue, the first IC tag being distributed to a user in advance and storing the first identification information, and the second IC tag being distributed to the user for each seat according to a reservation of a reserved seat, displaying reservation information, and storing the second identification information, the method comprising:
a control section of the server receiving reception information indicating whether the user has received the second data carrier from the user's cellular phone; and
storing identification information of the ticket in a nonarrival database as nonarrival information confirmed for reissuing a ticket when the user has not received the second data carrier when it is determined based on the received reception information that the user has not received the second data carrier.

40. A ticket use method for executing an authentication based on first identification information stored in a first IC tag and second identification information stored in a second IC tag by using the first IC tag and the second IC tag as tickets at an event venue, the first IC tag being distributed to a user in advance and storing the first identification information, and the second IC tag being distributed to the user for each seat according to a reservation of a reserved seat, displaying reservation information, and storing the second identification information, the method comprising:
a control section of the server receiving reception information indicating whether the user has received the second data carrier from the user's cellular phone; and
storing the first identification information in a nonarrival database as nonarrival information confirmed for reissuing a ticket when the user has not received the second data carrier when it is determined based on the received reception information that the user has not received the second data carrier.
